(19) United States
(12) Patent Application Publication
(10) Pub. No.: US 2008/0208749 A1
(43) Pub. Date: Aug. 28, 2008

(54) METHOD AND SYSTEM FOR ENABLING COMMERCE USING BRIDGE BETWEEN REAL WORLD AND PROPRIETARY ENVIRONMENTS

(76) Inventors: Andrew Wallace, Bellevue, WA (US); David A. W. Snelling, Kirkland, WA (US); Anatole B. Chen, Mercer Island, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/032,611

(22) Filed: Feb. 15, 2008

Related U.S. Application Data
(60) Provisional application No. 60/890,808, filed on Feb. 20, 2007.
(60) Provisional application No. 60/892,599, filed on Mar. 2, 2007.

(51) Int. Cl. G06Q 40/00

(52) U.S. Cl. 705/44

(57) ABSTRACT

A system, apparatus, and method is provided for enabling commerce transactions, and other forms of commercial activity among participants in a gaming or other forms of virtual environment and the real world, or between a participant in one virtual environment and a participant in a second virtual environment, using or taking advantage of the services of an Identity Bridge or Gateway. In particular, a real-time commercial activity system is implemented through user interface interactions, and middle-ware interactions. A financial transaction between the users is facilitated through a third party finance service provider, using proprietary identities of the users. Since the system obtains and verifies the relationship between proprietary and real identities of the users, the financial transaction can be facilitated in a secure and trusted fashion without revealing real identities.

### CROSS-REFERENCES TO RELATED APPLICATIONS

The present application claims benefit to U.S. Provisional Application No. 60/890,808, filed Feb. 20, 2007, the entire disclosure of which is incorporated herein by reference. The present application also claims benefit to U.S. Provisional Application No. 60/892,599, filed Mar. 2, 2007, the entire disclosure of which is incorporated herein by reference.

### BACKGROUND OF THE INVENTION

The present invention relates to methods of enabling commerce, communications, and other activities between participants in proprietary environments such as those found in on-line games, and more specifically, to an inventive identity and reputation platform and its use to facilitate commerce and other types of interactions while maintaining anonymity and other desirable qualities of participants' interactions with the environments.

Computer and video gaming, and participation in virtual on-line communities have grown to be a popular leisure activity as well as a significant source of revenue for software and game companies. The popularity of such games and virtual communities, and the development of new technologies has naturally resulted in efforts to extend those types of experiences to other platforms (e.g., mobile phones, PDAs, television sets, etc.) as well as to the development of different types of gaming or interactive experiences. One of the newer types of gaming experiences is that termed Massively Multiplayer Online games (or MMOs), also know as Massively Multiplayer Online Role Playing games (MMORPG). This type of gaming experience has developed in response to the availability of Internet connectivity and broadband access to the Internet.

In a typical MMO, a large number of players participate in the same gaming environment (or parallel versions of the same game) using the Internet or another suitable network to provide connectivity. The result is a real-time (or pseudo real-time) gaming experience involving multiple players who may act as individuals or be part of a team. MMOs may have between thousands and millions of players, each of whom typically pays a fee to participate, often in the form of a monthly subscription fee, by consenting (often by default) to viewing advertising material, or by agreeing to purchase items for use in the game. The games are often characterized by the creation of, and interaction with, an imaginary world or environment in which characters interact with each other and with other aspects of the environment. The imaginary world or environment may include landscapes of imaginary worlds, other creatures, weapons, tools, weather systems, forces or powers that act in the world, etc. In many gaming environments, players take on new identities (sometimes referred to as characters, avatars or personas) and use those identities or personalities as the basis for interacting with other players and the environment.

Variations on these types of games include Alternate Reality Games (ARG) and meta-games. These are games which create a world that blends online and real world experiences. For example, a detective style game might include clues found in an MMO, and clues found at a physical location. These games may be authored informally by experienced players rather than larger institutions, yet they still share many of the same characteristics.

Among other characteristics, participation in the games and virtual or simulated environments is immersive and time consuming. The popularity of the gaming and virtual community experience has resulted in a desire on the part of some players to participate in activities beyond the game or community itself. As such, a number of services and products have been developed to support this out of game/community participation, and such services or products are generically referred to as the “secondary market.”

As many people recognize the potentials of the secondary market, there has been a great effort to overcome several factors and obstacles currently preventing the secondary market from reaching its potential. However, it is hard to enable and/or facilitate interactions between players in a cross-world environment, such as commerce, messaging, social networking, and content exchange, among other beneficial and desired interactions.

As suggested by the rapid development of a variety of ancillary products and services, the popularity of MMOs and other forms of interactive gaming has led to the creation of a market for goods and services to be used with or within games. Further, some aspects of these products and services may exist and be obtained in (or facilitated by interactions with) the “real world”, that is in the physical world outside of the gaming or virtual environment. In addition, some MMOs and on-line communities have their own economies where commerce transactions may be facilitated, e.g., goods obtained within the proprietary environment can be traded or exchanged in order to support certain activities. For example, a participant may need some particular weapon for their avatar in order to complete a task within the game or be able to move on to a more advanced level of the game. In some cases, the weapon may be purchased from a vendor or other player in the game in exchange for in-game currency. The in-game currency may come from completing a task or challenge, demonstrating a specific skill or level of achievement, or another economic activity. Note that while currency is used as an example, trades can also be an exchange of non-currency goods, such as a transfer of skills, knowledge, game earned credits, or accumulated abilities.

Generating sufficient game currency or credits to obtain certain items or skills can be a time consuming activity. In response, a market has developed which matches people who have the time or ability to obtain in-game currency with people who are prepared to expend real world currency to make up for the lack of time they can devote, and yet seek to improve their enjoyment of the game environment. Further, some services—such as help in a particular task, or information needed to accomplish a task—can be just as valuable and tradable as goods (such as weapons, powers, tools, etc.) or game credits. In general, such a market facilitates transactions in which an item, information, or other commodity of value in one environment (e.g., a proprietary gaming environment or world) is exchanged for something of value in another environment (e.g., money in the real world). This is an example of an ancillary product or service in which aspects of either the product or service, or of the process of negotiating for and fulfilling a request for the product or service, may require activities that occur in both the real world and in a gaming or other proprietary environment.

As noted, a typical example of an activity or interaction that may involve both the real world and a proprietary environment is one in which a person desires to purchase in-game currency or credits from another game participant. Such a transaction may require communication of an interest in the purchase from a real world identity through their associated in-game identity to a second in-game identity (and as a result to that identity's associated real world identity), followed by negotiations for the purchase price and delivery terms, and eventually the transfer of real world money to an account belonging to the real world person who is associated with the second in-game identity (who is in possession of the in-game currency or credits). At each stage communications may need to flow between in-game characters and between an in-game character and the real world person in control of that character. In addition, game credits may need to be transferred from one in-game character to another, and real world currency may need to be transferred from one real world person to another. However, it is desirable that both the communications and transfers be done without interrupting certain desirable aspects of the experience of the game players or user of a proprietary environment, including retaining a desired degree of anonymity by not disclosing the connection between an in-game character and the real world person associated with that character.

Further, there are certain functions, features, and activities which those participating in a gaming environment or other form of virtual environment may desire to have available as part of the gaming or other experience. These include communications (e.g., messaging), social networking, commerce transactions, interactions with other players, the ability to co-ordinate the accomplishment of certain tasks, and other beneficial activities. However, optimally and safely performing these activities often requires interacting or fulfilling obligations in both the virtual (e.g., gaming) environment and the real world, or exchanging information between them.

What is desired is a system and method to overcome the above mentioned factors and obstacles of second market in a gaming or other virtual environment and the real-world and to enable commerce transactions and other desired forms of interaction between participants in the virtual environment and the real world.

### SUMMARY

The present invention is directed to a system, apparatus, and method for enabling commerce transactions, and other forms of interaction between participants in a gaming or other form of virtual environment and the real world, or between a participant in one virtual environment and a participant in a second virtual environment (typically using a connection to the real world as an intermediary stage of the transaction). The invention enables these and other types of interactions to occur with a sufficient degree of trust between the participants to encourage such interactions, while at the same time not compromising certain desired characteristics of the gaming or other experience, such as immersion in the experience and the ability to maintain a high degree of anonymity. In particular, a real-time commercial activity system is implemented with user interface interactions, and middle-ware interactions. A financial transaction between the users is facilitated through a third party finance service provider, using proprietary identities of the users. Since the system obtains and verifies the relationship between proprietary and real identities of the users, the financial transaction can be facilitated in a secure and trusted fashion without revealing real identities.

In accordance with an aspect of the present invention, a computer implemented method is provided for facilitating a commerce service within a Cross World environment by utilizing a identity managing system that verifies a user's identity for the commerce service. The method includes obtaining an active identity of a first user, receiving from the first user a request for a commerce transaction and determining a type of the commerce transaction, such as selling, buying, trading, etc., and an item related to the request. The method further includes identifying a group of users whose profile information is relevant to the item and broadcasting a message about the request to the group of identified users. The profile information includes information about a particular user, for example, a seller user who indicates to sell the item. An active identity of a second user is received wherein the second user is selected as a participant of the commerce transaction. Upon receipt of the active identity of the second user, the commerce transactions including a financial transaction between the first user and the second user are facilitated. After the commerce transactions are facilitated, the request received from the first user and a result of processing the request are stored as part of history. In an aspect of the method, the financial transaction is facilitated via a third party finance service. A notification about the financial transaction is transmitted to the first and second users.

In accordance with another aspect, a system for providing a commerce service within a Cross World environment by utilizing an intermediary system that authenticates an active identity of a user for the commerce service is provided. The system comprises a managing component, a market agent component, and a storage component. The managing component is configure to provide a list of proprietary identities associated with a first user when the first user logs onto the system, receive from the first user an active identity selected from the list of proprietary identities associated with the first user and receive from the first user a request for a commerce transaction. The managing component forwards the received request to the market agent component. The market agent component is configure to process the request to determine a type of transaction and an item related to the request, identify a group of users whose profile information is relevant to the request and broadcast the request along with the active identity of the first user to the group of the users.

In accordance with yet another embodiment, a computer implemented method is provided for facilitating a financial transaction within a Cross World environment wherein a user registers a proprietary identity to represent the user's real identity for the financial transaction, the proprietary identity being verified through a third party service. The method includes receiving a request for the financial transaction between a first user and a second user, the request including proprietary identities representing the first and second users and obtaining real identities of the first user and the second user based on the proprietary identities. Additional information necessary for completing the financial transaction is obtained. Using the real identities of first user and the second user, the financial transaction between the first user and the second user is facilitated. The method further includes generating a message to notify about the performed financial transaction and transmitting the message in which the proprietary identities is used to represent the first user and the second user. The history of the financial transaction is stored in a data store of the third party service.

### BRIEF DESCRIPTION OF THE DRAWINGS

FIG. 1 is a block diagram illustrating a system environment that enables a Cross World commerce interaction or transaction;

FIG. 2 is a functional block diagram illustrating the primary functional components or structures of one form of a Cross World commerce interaction or transaction that includes use of an embodiment of an Identity Bridge system;

FIG. 3 is a functional block diagram illustrating the primary functional components of an embodiment of the present invention;

FIGS. 4A-4E are screens illustrating exemplary user interfaces in some embodiments of the present invention;

FIG. 5 is a flowchart illustrating an exemplary process for facilitating Cross World commerce transactions by using the Identity Bridge system in some embodiments of the present invention;

FIG. 6 is a flowchart illustrating an exemplary process for implementing commerce transactions in a particular market place service in accordance with some embodiments of the present invention;

FIG. 7 is a flowchart illustrating an exemplary process for implementing financial transactions between two users in the Cross World environment in accordance with some embodiments of the present invention;

FIG. 8 is a flowchart illustrating an exemplary process for posting an item for sale in the Market Place Service in some embodiments of the present invention; and

FIG. 9 is a flowchart illustrating an exemplary process for presenting a user with a list of relevant users or relevant items in some embodiments of the present invention.

### DETAILED DESCRIPTION

### Underlying Concepts

Prior to describing the present invention and certain of its embodiments in greater detail, it is helpful to introduce one of the underlying concepts that will be discussed and which is important to understanding the context of the invention. This concept is that of a gaming environment, virtual environment, or other form of “Proprietary World” and the physical, external world, which is a form of the “Real” or “Open” world.
Proprietary World: a world or environment created, owned and typically operated by an entity such as a corporation, association, cooperative, institution, organization or individual. The entity is typically responsible for creating, modifying, and policing the rules, regulations and laws governing participation in that world. An example would be the virtual world or environment created for a computer game in which game players participate. Another example would be a virtual world created to mimic the real world, such as a simulated environment or society; and
Open (Real or Physical) World: a world where corporations, institutions, organizations and individuals participate and interact amongst each other. Such a world cannot be owned by those entities. Generally, the government of a country (e.g., as recognized by the United Nations) is responsible for creating, modifying and policing the rules, regulations, and laws that govern interactions between participants in this world. A corporation or institution may define additional rules and regulations that apply to its own internal and external interactions, but these are subordinate to the rules and regulations of the governmental entity. An example would be the “real” or physical world in which people participate in interactions with each other and with institutions such as banks, businesses, etc.

Note that one distinguishing feature of Proprietary and Open worlds is that Proprietary worlds may be turned off, or suspended, (although the managing entity may prefer to avoid such events), while an Open world cannot be turned off. Further, in an open or real world, people typically interact using their own identity (that is, unless they are pursuing an illegal or otherwise unpopular activity), which is verifiable by accessing certain governmental organizations (such as the police, social security office, etc.).

As will be discussed, the present invention relates to “worlds” or “environments” in which real people or representatives of real people (such as personas, owned or controlled characters, avatars, etc.) interact. A world may be considered to be an environment of rules and laws in which people participate either as themselves, or as an entity that represents themselves. Such worlds are generally self-contained and may operate independently of interactions with other worlds.

In some embodiments, systems, architectures, apparatus, and methods are provided for implementing services, functions, and features that enable or facilitate interactions among participants in a “cross-world” environment. The “cross-world environment,” as used herein, refers to an environment including a real world and Proprietary worlds. In some embodiments, the interaction will be between a first person in the real world (who is represented by an avatar or similar construct in a virtual environment) and a second person in the real world (who is represented by a second avatar or similar construct in the same virtual environment), where the direct communications will be between the participants' avatars instead of the actual physical people represented by those avatars. Further, although the present invention will generally be described with reference to enabling interactions between participants in the same gaming or virtual environment, the interactions may be between a participant in a first gaming or virtual environment and a participant in a second gaming or virtual environment, or between a participant in a gaming or virtual environment and a second participant acting in the real or physical world (and hence represented by their own, actual identity). Note that in the case of an interaction between participants in the same or different gaming or virtual environments the invention may be used as an intermediary element that couples each Proprietary environment to the real world, and hence to each other. Note further that when acting in a gaming or virtual environment the participant will generally be represented by a fictitious persona or character (e.g., avatar) that they have created and/or become associated with.

It is noted that the communication, transaction or interaction itself may take place wholly or partially within a gaming or virtual environment, between one or more gaming or virtual environments, or between a gaming or virtual environment and the external real world. The communication, transaction, or interaction may involve messaging (email, instant messaging, etc.), blogging, a transfer of images or video or other form of communication, a commerce transaction, a sequence of actions or tasks, an exchange of information or data, or other form of interaction. The communication, transaction or interaction may involve a transfer of information, credits, or other item of value in the Real world or Proprietary environment.

Although some of the game or virtual environment play is close to real life work in its repetitiveness and tediousness, it is pursued with enthusiasm and perceived to be fun. Research conducted by the inventors has led them to believe there are several components to the source of this enthusiasm:
Flow: This is the concept that people can achieve a state of concentration on a task that blocks out other thoughts and enables them to achieve a sense of mastery. Flow can be found among assembly line workers, office workers, sports players, and game players. Participants in Proprietary environment activities find the flow to be immersive and extremely rewarding;
Reputation: This is a measure of the recognition that a person achieves for their avatar or representation within a gaming or virtual environment, or other form of community. It may be a reflection of the achievements of that person within the game or environment, and is more valuable when other community participants, or peers, have an appreciation of what those achievements have required or represent in terms of game-playing skills, etc. As such, building a reputation is both valuable and rewarding to the participant; and
Rewards: The prospect of a reward for certain activities, whether challenging or not is motivating to most players, and can be managed by the operators of the gaming environment to encourage intense participation. Rewards may include in-game or in-environment currency, gifts of virtual items, the enabling of additional activities, skills, or powers, and an increase in game reputation, for example.

Participating in Cross World activities (either between open and Proprietary worlds, or between different Proprietary worlds), such as commerce transactions in the secondary market, implicates these characteristics in at least the following ways: (1) the sense of Proprietary world flow or in-world involvement is interrupted by the experience of moving to the different user experience of using browsers, finding sites, managing content, etc.; and (2) reputation or other advantageous associations obtained in the gaming or other virtual environment are not transferred to (or associated with) the secondary interactions because there is no verifiable connection between the in-world avatar and the secondary market participant acting as part of the real world.

A major issue of the Cross World commerce activities relates to participants' desire for anonymity. Participants in gaming and other forms of virtual environments generally want to keep the relationship between their real world identity and their Proprietary World identity secret. Reasons for this preference may include enhancing the immersive experience and providing security from the behaviors of other Proprietary world participants—particularly as some game or virtual environment behaviors are not appropriate open world behaviors.

As discussed above, there are presently no optimal approaches to providing the types of services and functionality desired by many gaming and virtual environment participants, subject to the described constraints and the participants' desire to retain the benefits of immersion, trust, and anonymity. In some instances, reputation may be used to enforce a good practice in commerce transactions because a person tries to maintain a good reputation in a Proprietary world. Generally, an aspect or characteristic associated with a player or Proprietary world participant deems to be valuable to that person. As such, a participant's reputation provides one way in which other participants can obtain confidence in a party with whom they may desire to conduct a transaction, and hence act to enable such transactions. In one embodiment, the transportable global reputation system and methods are utilized in various commerce transactions or interactions, and thereby facilitate and enable those transactions or interactions between participants in Proprietary and open worlds. However, players participate in more than one game or virtual environment (sometimes in parallel, meaning two or more games at the same time, and sometimes sequentially, meaning moving from game to game as they are released onto the market), and sometimes may be represented by multiple identities in the same game. And each time the player moves to a new world or virtual environment, the valuable commodity of reputation is set back to zero or to some nominal level, representing a potentially considerable loss in a commercial sense that can only be regained over time and by expending effort.

In some embodiments, an identity management and verification, and transportable global reputation system and methods of the present invention (hereinafter, “Identity Bridge” system) may be used to solve the problem of bringing together identities and reputations gained in different worlds (be they open, real, or Proprietary) in such a way as to enhance participation in secondary markets. Among other aspects, the inventive system, architecture, processes and methods operate to enable commerce transactions among participants in the Cross World environment with tools to manage their identities and related data, verify another's claim of ownership to an identity, and verify the alleged association between certain characteristics or attributes of an identity and that identity (and hence the accomplishments or qualities of a real world person), thereby enabling a transfer of reputation between worlds or environments.

### Identity Bridge or Gateway

In Proprietary Worlds, a user may use different names or the same name in different worlds. It is therefore extremely hard to determine whether that part of the transaction happening in one world is with the same participant in the other world. Further, it is difficult to determine whether to transfer levels of trust or reputation between the users in different worlds unless some connection between the users is identified. One of the benefits of Proprietary Worlds may be that of anonymity. This enables the user to be someone or something very different in each world. However, the Cross World transactions generally require real identities that correspond to Proprietary World identities. This makes Cross World transactions, particularly those involving commerce, to be typically composed of two separate transactions. That is, the participants will complete one transaction in an Open (Real) World and a corresponding transaction in a Proprietary World. A Cross World transaction can only be considered to have been successfully completed if both individual transactions are completed successfully. However, since both transactions happen in different worlds, it is difficult to achieve or verify this result using conventionally available approaches.

In some embodiments, a method and system are provided to enable commerce transactions or other activities among participants in the Cross World environment while allowing the participants to use Proprietary identities. It is noted that an intermediary system, such as an Identity Bridge System, may be applied to a number of activities and types of interactions, including, but not limited to commerce, banking, social networking, messaging, content exchange, etc.

As discussed above, a participant's reputation may provide one way in which other participants can obtain confidence in a party with whom they may desire to conduct a commerce transaction, and hence act to enable such transactions in a Cross World environment. The Identity Bridge System that brings together reputations gained in different worlds is used to verify and authenticate the Proprietary identities used in the Cross World environment. Thus, the method and system can enhance participation in the Cross World commerce, for example secondary markets, without losing the sense of flow or immersive experience in the Proprietary worlds.

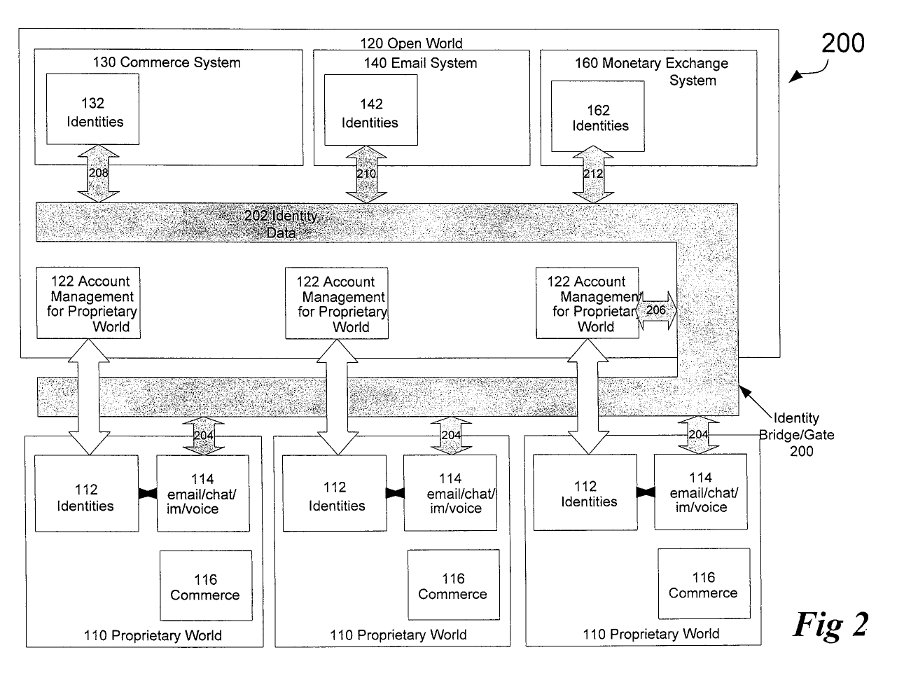

FIG. 2 is a functional block diagram illustrating the primary functional elements or structures of one form of a Cross World commerce interaction or transaction that includes use of an embodiment of an Identity Bridge or gateway 200. It is noted that the Identity Bridge or gateway 200 may be implemented in multiple forms, architectures, or structures, including, but not limited to, a service or web service, a client-server architecture, a computer implemented method, a network connected data storage medium coupled to a processor that executes instructions that implement the functions and processes of the invention, etc. By the way of example, the Identity Bridge may be implemented as part of a client-server architecture in which users communicate and exchange data with a server using a suitable communications network. The server, for example an Identity Bridge System, includes a processor executing instructions that implement the functions or services of the invention. The client may be a browser, software widget, or form of software agent that is capable of interacting with the server and providing a user UI or other functions as may be needed or desired. As will be discussed, the inventive bridge or gateway 200 is used to enable or facilitate commerce, communications, and other desirable functions or interactions between the Real World and Proprietary World or between Proprietary Worlds, while retaining desired aspects of the Proprietary world experience.

Referring to FIG. 2, element 202 represents identity data stored in or otherwise accessible from bridge or gateway 200. Identity data 202 represents identity information that a user of bridge or gateway 200 might provide as part of a registration process, where registering with the bridge or gateway enables the user to utilize the services and functions of the bridge or gateway. Such identity data would typically include a username and password, along with other data that may be requested as part of a registration or authentication process. By registering with bridge or gateway, or associated service 200, a user is able to perform various functions related to managing their identities for multiple worlds and/or verifying the identity or reputation of another user (where such verification would typically occur as part of determining if a user wished to engage in an interaction with another user).

Elements 204 represent a connection (or connections) or other form of enabling data transfer between bridge 200 and the communications systems (shown as elements 114 in the figure) within the Proprietary Worlds. Elements 204 couple bridge 200 to communications systems 114, thereby enabling bridge 200 to exchange data between the real world 120 and one or more Proprietary worlds 110, or between Proprietary worlds. The data exchange can be part of a process of verifying the identity of a prospective participant to an interaction, of associating one identity with another, etc. In general, bridge 200 and its related services and functions provide users with confidence that an identity they interact with via the bridge is being manipulated by the user who is rightfully entitled to utilize it, and if applicable, that the user associated with the identity with which they are interacting is possessed of a reputation or resume of accomplishments that can be accepted as accurate. Coupling the bridge to the communication systems of the Proprietary world(s) enables the inventive bridge to connect with most Proprietary Worlds without requiring custom engineering or the development of business relationships for and between the Proprietary Worlds' managers.

The coupling may be achieved in a variety of ways. In some embodiments, participants are used to achieve the coupling. The system delivers tasks to willing participants in the open world aspect of the system who then enter the Proprietary world to perform the task with their Proprietary world identity. For example, one task conducted using the system is for a user to send a verification message crafted by the system to the requested recipient. Other types of tasks are also possible, such as verifying certain attributes or achievements of the intended identity, participating in a service, or simply conveying a message, and so on.

Element 206 represents an alternative connection between bridge 200 and a Proprietary World coupled to bridge 200. Connection or coupling 206 is depicted as a direct relationship between bridge 200 and the management functions or entity 122 of one or more Proprietary Worlds, instead of between bridge 200 and the communications system 114 of such worlds. The primary benefit of such an implementation of the connection would be simplicity and elimination of the delays associated with user interaction. However, a disadvantage of such an implementation is the need for a technical and possibly business relationship between the bridge and the Proprietary world, which is sub optimal for some or all the reasons described previously. Nevertheless, certain worlds may justify the investment cost if adequate business relationships can be established for those particular worlds.

Elements 208, 210, 212 represent a connection, coupling or other form of data transfer or exchange between the identity data (or data store) of a user of a real world commerce system 132, communications system 142, or other system 162 (here depicted as monetary exchange system 160), respectively, and the inventive bridge or gateway 200. In each case or use of the indicated open world system (e.g., commerce system 130), the identity data exposed to the inventive system by a user is the identity the user has deemed most appropriate for the interaction, transaction or system involved. Typically, this is the real world identity relevant to (e.g., associated with) the Proprietary World that the transaction or part of the transaction is designed to occur within.

Note that with the inventive bridge 200 used to manage data such as identities and reputation, and the resulting trust between participants that is engendered, it is now possible to engage in activities that were not possible without use of the bridge, or to have a more desirable experience when engaging in those activities. Enabled activities include: Creation of a resume or curriculum vitae capturing achievements made in a range of Proprietary worlds in a verifiable manner; Creation of businesses that can use verified identities and reputation to deliver services; and Creation of games that demand verifiable achievements in multiple worlds.

Current activities which may be enhanced by the inventive bridge include:
Sale of a good in a Proprietary world in return for money in the real world. The sales cycle is simplified and more immersive using the bridge; and
Participation in forums and blogs. Verified game identities appropriate to the subject Proprietary world can be used rather than real world identities which may have no particular connection, thus raising level of integrity and trust, and retaining the immersive experience.

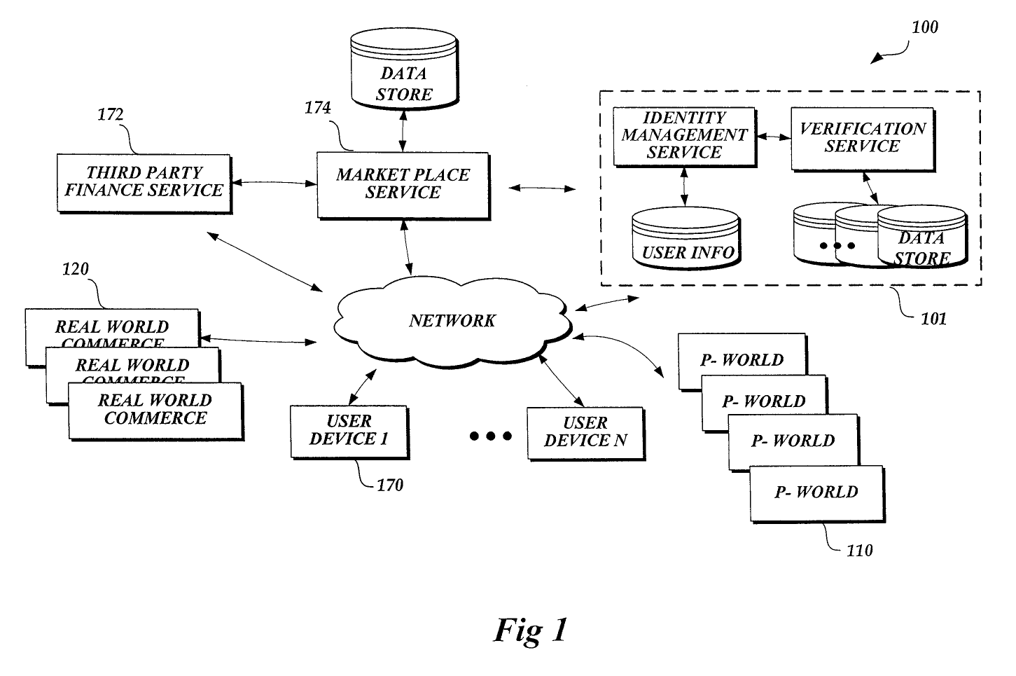

Referring now to FIG. 1, a block diagram depicts an exemplary system environment 100 that facilitates and enables Cross World commerce activities in accordance with an embodiment of the present invention. In the exemplary system environment, a user uses a user device 170 to connect to the Proprietary worlds 110 and Real world 120 for various Cross World activities including commerce transactions. A user device 170 that is designed for easy Cross World transactions may be used. However, any sophisticated user interface may be good enough to facilitate Cross World commerce transactions. The user device 170 may have functionality to capture images of items or services for trade. In some embodiments, a user device 170 that is designed for supporting easy communication or commerce transactions may be used. For example, the user device may have functionality to capture images of items for trade. The user device 170 may include a desktop personal computer, workstation, laptop, etc., or a personal digital assistant (PDA), mobile phone, or any other wireless access protocol (WAP) enabled device or any other computing device capable of interfacing directly or indirectly to the Internet or other network connection.

In a particular embodiment, the exemplary system environment includes a commerce service system that provides market place services for secondary markets where the users can sell or buy Proprietary World items to/from other users in exchange for money in the Real world 120. An item, as used herein, refers goods, services, skill sets, rewards, etc that are available for a particular Proprietary World. In some embodiments, the sales cycle is simplified and more immersive using the exemplary system environment. The market place services may include services such as posting of items for sale, or wanted to buy, advertising and/or enhancing the listings of such items, connecting buyers and sellers, transferring funds between buyers and sellers, obtaining fees and/or commissions from buyers and sellers for services, enabling voting and reputation to be developed for buyers and sellers, viewing of reputations by and of buyers and sellers, and maintaining and an auditable trail of transactions back to Open World identities, while enabling buyers and sellers to remain behind their Proprietary World identities.

As will be discussed, among others, commerce transactions are those of the need for the identity management service and the provision of verifiable identity and transportable reputation functions. The exemplary system environment 100 includes an Identity Bridge system 101 comprising a verification service and identity management service. The Identity Bridge system 101 is an embodiment of the Identity Bridge and gateway 200 illustrated in FIG. 2. In one embodiment, each user registers with the identity management service. Generally, a user may provide identity information as part of a registration process, where registering with the bridge or gateway enables the user to utilize the services and functions of the bridge or gateway. Such identity data would typically include a username and password, along with other data that may be requested as part of a registration or authentication process. The verification service and the identity management service may include storage (data stores) to store registered user information, service history information, etc. After the registration, the user is given a registered identity that is associated with various Proprietary World identities that are managed by the identity management system. By registering with bridge or gateway, or associated service 200, a user is able to perform various functions related to managing their identities for multiple worlds and/or verifying the identity or reputation of another user (where such verification would typically occur as part of determining if a user wished to engage in an interaction with another user). The commerce services (e.g., Market Place Service system 120) may be coupled to the verification service and identity management service for facilitating commerce transactions. In the commerce services, each user may be able to select a desired Proprietary identity for a particular commerce transaction. The exemplary environment may include a third party finance service provider 172 for secure money transactions. As will be discussed in a greater detail, the third party finance service provider may be any suitable online financial service provider that is to be trusted to retain privacy and money, but may also be required to reveal the relationship under pressure of real world government or legal demands.

It is noted that, additional systems, use cases, value propositions, and types of interactions are enabled and/or facilitated by the solving of these and other problems. For example, Alternative Reality Games and Meta-Games (such as Cross World games created by participants for other participants) are more readily created using a system which has solved these problems and the experience enriched by enabling use of world appropriate identities. Another example is club or guild membership, which is simplified when an identity management system for multiple worlds is available.

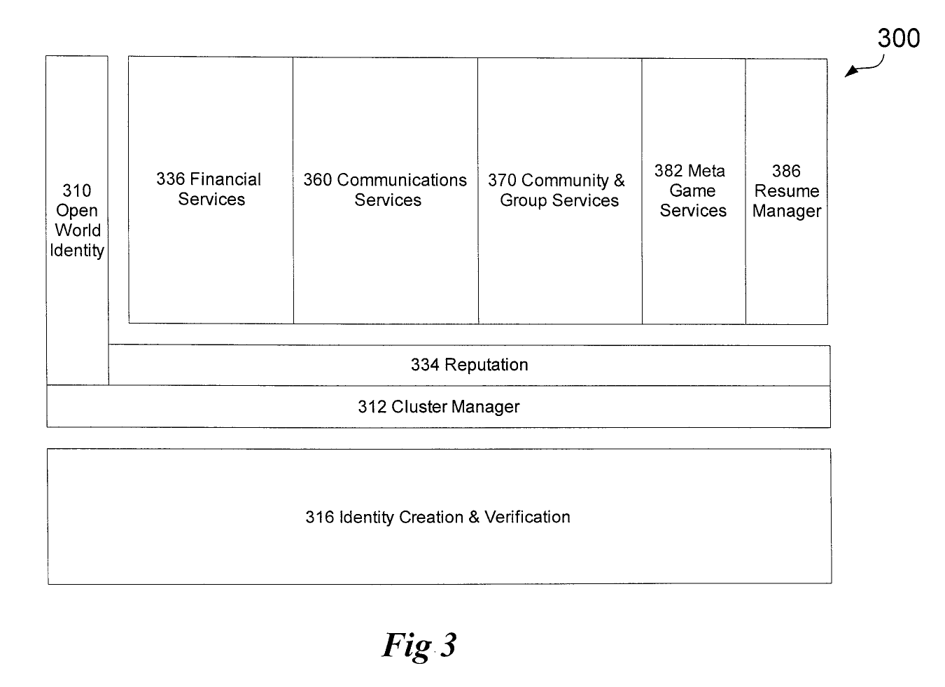

FIG. 3 shows the primary functional elements of the system that facilitates the above mentioned Cross World activities by using the Identity Bridge system 300. As discussed, the Identity Bridge system 300 enables participants in the Open World to connect with each other using Proprietary World identities. By registering with the Identity Bridge system 300, a user is able to perform various functions related to managing their identities for multiple worlds and/or verifying the identity or reputation of another user (where such verification would typically occur as part of determining if a user wished to engage in an interaction with another user).

In some embodiments, such verified identities are used for communication, such as messaging, chatting, blogging, and sending notifications and alerts to participants who are online, offline, or mobile while guaranteeing anonymity of Proprietary World identities. The functions, features or processes shown in FIG. 3 are examples of those that can be implemented as part of the Identity Bridge or Gateway 200 shown in FIG. 2, but are to be understood as exemplary and not required in all embodiments of the invention. One or more of the elements or processes depicted in the figure may be implemented in the form of hardware, firmware, web service, application programming interface (API) or form of software, or a combination of such forms. For example, an element may be implemented as a set of instructions that form a software routine that is executed by a processing element. The processing element may be contained in a computing device such as a server, for example, with the server communicating with a real world user via the user's client device or software and a suitable communications channel or network. The primary function, process, or service provided by each of the depicted elements will now be described.

Elements 310, 312, and 316 generally represent the Identity Bridge system 300 that may enable or facilitate Cross world activities while retaining desired aspects of the Proprietary world experience. An example of one implementation of such a feature or function that may be utilized with, or as part of, the present invention is described in additional detail in U.S. patent application Ser. No. 11/955,269 entitled “SYSTEM, APPARATUS AND METHOD TO FACILITATE INTERACTIONS BETWEEN REAL WORLD AND PROPRIETARY ENVIRONMENTS,” the contents of which is incorporated by reference in its entirety. Thus, the details of the Identity Bridge system 300 will not be discussed.

Element 310 represents a function, process or service that enables a user to register their real or open world identity with the Identity Bridge 200, or if already registered, to access the bridge functions and services by logging into the system. As has been discussed, and will be discussed further, the Identity Bridge or gateway enables this real world identity or identification data to be linked to or associated with one or more sets of Proprietary world identity or identification data in a manner that engenders a trusting relationship between prospective participants to an interaction, while maintaining certain desirable aspects of a participant's involvement with those Proprietary worlds.

Element 312 (Cluster Manager) represents a function, process or service that connects a user's Real or Open World identity to one or more of their Proprietary World identities. In some embodiments of the invention, Cluster Manager 312 does not reveal the relationships externally. Among other functions, Cluster Manager 312 enables a participant in a Proprietary world to select which of one or more Proprietary world identities they desire to expose to another participant. Note that Cluster Manager 312 may cause the execution of element 316 (Identity creation & verification) in response to actions or commands by the user.

In addition to the above mentioned elements, there are various elements that are implemented as part of the Identity Bridge or gateway 200, for example, Element 334 (Reputation Manager) for representing a function, process or service that enables participants to view and assess others' reputation as Proprietary World participants without having access to information that would enable them to determine the associated Real or Open World identities, Element 360 (Communications Manager) representing a function, process or service that enables a variety of communications systems and methods to be used by a participant in a transaction or interaction, or the like.

Element 336 (Banking Services) represents a function, process or service that enables desirable banking services, including but not limited to, payment, reconciliation, currency exchange, and related services for interactions involving participants in Proprietary environments. Some examples of possible interactions enabled or facilitated by element 336, such as Advertising, Bazaar (real time trade), Subscriptions, Credit Services, Escrow Services, Auctions, Store Fronts, New Business Models represent functions, processes or services that correspond to implementations of business models partially or fully enabled by commerce services element 336. In a preferred embodiment, the Element 336 (Banking Services) may be implemented as a third party finance service provider that is an independent entity from the Identity Bridge system.

An advantageous feature of an Identity Bridge system 300 is that two views may be generated for each part of each transaction. The first view shows the participant information (such as a transaction history) using their real world identity. The second view shows the same information using Proprietary world identities. The system 300 would optimally filter access to each view such that only the owner of an identity would be able to make the connection between the real world and Proprietary world identity. The system 300 would optimally further filter to ensure that the connection between multiple Proprietary world identities was not apparent, unless the owner chooses to reveal such connectedness. A variety of book keeping functions can also be implemented by the system using this information to deliver additional benefits to users in terms of tracking identities and the related activities of those users owning those identities.

New business models that are enabled include, but are not limited to, the creation of meta-games that might charge an entry fee, and micro-businesses in which the owner wishes to be totally known by their Proprietary world identities.

Note that in such transactions or interactions, at least one participant will typically be represented by a Proprietary World identity. In order to facilitate such transactions or interactions while retaining certain desired aspects of participation in a Proprietary world, messages or other forms of communication can be exchanged between participants (in either the Real World or a Proprietary World) without exposing a Real or Open World identity. Further, messages or other forms of communication directed to an identity in a user's cluster or group of identities can be managed, so the user can participate using whichever one or combination of their Proprietary World identities they select.

Examples of communication services or methods that may be enabled or facilitated by a communication service 360 include chat, email and voice communications. Note that communication service 360 will typically interface with, or be coupled to, any required Real or Open World Communications systems to enable such communications.

Element 370 (Community & Group Services) represents a function, process, or service that enables participants to engage in social networking activities. Some possible examples of such activities include forming and managing clubs or groups, writing, viewing, and managing web logs (blogs), seeing and interacting with other participants, creating, viewing, and managing their own web pages, and showing pictures, videos, or sounds of their achievements in various Proprietary worlds.

An advantageous feature of an Identity Bridge system 300 is that all such activities may be reliably related to Proprietary world identities without reference to their open world identity.

Element 382 Meta Game Services represents a function, process, or service that enables participants to engage in structured or semi-structured activities that relate to one or more Proprietary worlds and are created and managed by the participants in the Identity Bridge system 300. Some possible examples of such activities include authoring and managing games that include objectives to be obtained in one or more Proprietary worlds (possibly including the real world), creating and managing businesses that deliver goods or services to participants in one or more Proprietary worlds (including the real world), and forming or managing clubs or associations made up of participants and their Proprietary world connections.

Element 386 (Resume Manager) represents a function, process, or service that enables participants to build a resume made of their Proprietary world identities and achievements. An advantageous feature of a resume using an Identity Bridge system 300 is that the information it contains is a composite of verified information from one or more Proprietary worlds.

### Cross World Commerce

While the existing commerce system has enabled users to exchange goods and services in a transaction between Open and Proprietary Worlds, there have been several undesirable side effects. These include the following: both users have had to reveal their Open World identities; both users can now map the other's Proprietary World identity to an Open World identity; and both users have experienced breaks in their Proprietary World experience. Further, a buyer user would have either received little assistance from the existing commerce system, or had to enter a variety of data to assist in determining which goods and services were appropriate to his/her Proprietary World.

The identity registered with the Identity Bridge System may be used to hide real name or identities of buyers, sellers, bidders in Cross World commerce system. Also, the names appearing on advertisements, the names displayed in a signature image, file, sources, alerts, notifications, etc. may be replaced with a Proprietary World identity associated with the identity registered with the Identity Bridge System.

In some instances, the name or knowledge of the Proprietary World identity may be used to narrow the scope of search on an item. For example, in a commerce system, a filter could be built using knowledge of an identity's source that would only show goods and services for the particular Proprietary World that would be useful to the participant's identity. In addition, the Cross World commerce system may enable the participant to determine a set or subset of their Proprietary World identities to be visible to viewers of a particular identity. Note that any step in the Cross World commerce system where a real world commerce transaction takes place, such as the exchange of money, etc. would be assisted through a third party finance service provider which keeps the real world identities hidden from each other.

There are various ways to implement the third party finance service provider in conjunction with the Identity Bridge system. One way is that the third party does not have a Proprietary identity or registered identity information about the parties of a transaction. The Identity Bridge system may request a money transaction with parties' real identities. In some embodiments, the third party will receive a transaction request with the registered identities and obtain real identities of the parties from the Identity Bridge system and then complete financial transaction with real world identities associated with the registered identities.

Upon completion of the transaction, the third party service provider may notify the Identity Bridge system with a notification along with the registered identity. The system may match up the registered identity with a selected propriety identity for the transaction and generate a notification of the transaction for the parties. The notification will contain the propriety identities instead of the real or registered identities of the participants. As mentioned above, the third party service provider may be any suitable online financial service provider that is to be trusted to retain privacy and money, but may also be required to reveal the relationship under pressure of real world government or legal demands. Since the Identity Bridge system hides real world identities of participants from each other, participants depend on understanding the reputation of other participants in their Proprietary World identities.

### General Commerce Transactions

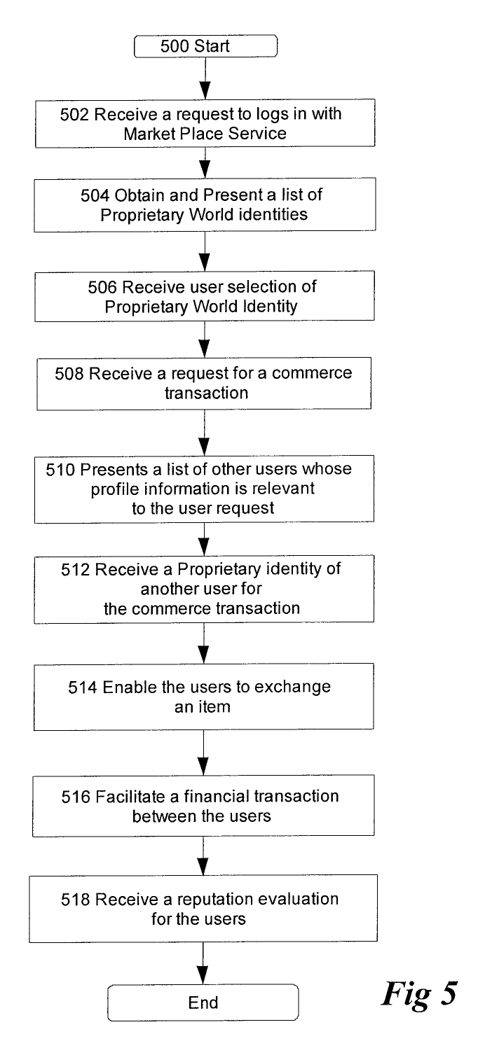

With reference to FIG. 5, a flow diagram depicts a routine 500 for facilitating Cross World commerce transactions using the Identity Bridge system in accordance with an embodiment of the present invention.

It is assumed that, in order to engage in Cross World commerce, a user needs to register his/her Propriety world identities and Real world identity with the Identity Bridge system. After such registration, the user will be given with a registered identity and a password. If the user wants to register a new Proprietary identity to the Identity Bridge system, the user claims (or creates) an identity from a Proprietary World. If the Proprietary World identity is previously created, the user asserts that he/she is responsible for the particular identity. After proper verification, the Proprietary identities of the user are associated with the registered identity and stored in the data store of the Identity Bridge system. The relationship between the User and the selected Proprietary World identity is verified through the verification service. Upon verification, the user is registered with the management system and is given with a registered identity. The system will store the user's real world identity information and Proprietary identity information that are associated with the registered identity.

Users may use the registered identity to log on the Market Place service system (server) that is communicatively coupled to the Identity Bridge system. “Buyer,” as used herein, refers to a user who wants to purchase a Proprietary World item, service, skill sets, rewards, etc. (hereinafter, “item”) available for a particular Proprietary World from another user. The buyer may not need to have a Proprietary World identity of the particular Proprietary World.

“Seller,” as used herein, refers to a user who wants to sell item available for a particular Proprietary World. The seller is generally a user of the particular Proprietary World or at least any user with a good reputation as a seller (i.e., the Market Service may filter a potential seller based on his/her reputation).

In step 502, the Market Place service system receives a request from a user. The user logs on the Market Place service system with the registered identity. In step 504, the Market Place service system obtains a list of Proprietary World identities associated with the user and presents the list to the user. The user selects a desired Proprietary World identity as an Active identity that will represent the user during the commerce transaction. As mentioned above, the user can create, register and use a new Proprietary World identity if necessary. In some embodiments, the user can designate a desired Proprietary World identity for an Active identity that will represent the user during the commerce transaction. In such embodiments, the designated Proprietary World identity is verified against the user's Real world identity through the Identity bridge system.

If the user wants to purchase an item, the user plays a role of a “buyer.” Likewise, if the user wants to purchase an item, the user plays a role of a “seller.” In step 506, the service receives the user's selection indicating which Proprietary World identity is to be used for an active identity.

In step 508, the Market Place service system receives a request for a commerce transaction. As will be discussed below, the request for commerce transaction can be received in many different ways. The commerce transaction includes, but is not limited to, selling an item, buying an item, trading items, etc. In step 510, upon receipt of a request from the user, the Proprietary World identities of the users whose profile information is relevant to the request may be presented to the user. For example, if the request is to buy an item, the Market Place service system query a data store to obtain a list of sellers who have indicated to sell such item or similar items and present the list to the user. The list of sellers may be presented in a certain order. For example, the user can specify his/her preference for display ordering of the sellers or items. The reputations of the sellers are also provided along with description of item, price information etc. As discussed above, the reputation of a seller is the reputation of the active identity that represents the seller. In some instances, several Proprietary World identities belong to one seller. If the seller uses several Proprietary World identities to sell items, the user will see several sellers with different reputations. In some embodiments, an accumulated reputation may be used. The accumulated reputation may be derived from the performance of a set or subset of all Proprietary World identities that belong to a user. Such information may be helpful for participants who are relatively new to a particular Proprietary World because the accumulated reputation can be viewed as a history of performance or behavior of the buyer or the seller. In these embodiments, if the seller uses several Proprietary World identities to sell items, the user will see several sellers with one accumulated reputation.

The user and the potential sellers may negotiate and communicate to agree on a transaction of an item. After the negotiation and communication, the user selects one potential seller (a second user) as a party for the commerce transaction. In step 512, the service receives a Proprietary World identity of the second user (e.g. a seller) for the commerce transaction. In step 514, the Market Place service system may enable two or more users to exchange the item. Typically, the Proprietary World where the item can be used may be the environment for the users to exchange the item. Note that in some circumstances, Step 514 may not be needed since the nature of the Proprietary identities may implies which Proprietary Worlds being considered, the means of communication, and the means of Exchange. However, negotiation may still occur between the parties.

In step 516, the Market Place service system facilitates a financial transaction between the users. Preferably, a financial transaction is completed through a third party finance service provider. In one embodiment, the financial transaction can be completed through a finance service component of the Market Place service system. Since the Market place service system obtains and verifies the relationship between Proprietary and Open World identities (real identities) through the Identity Bridge system, the financial transaction can be facilitated in a secure and trusted fashion without revealing real identities.

In some embodiments, items or services may be transferred among the users via the Market Place service system only after the finial transaction is completed. Since the users for example, buyer and seller, have been using their Proprietary World identities, there is no need for them to expose the relationship to their real identities. In some embodiments, the items or service are exchanged before the financial transaction. As will be appreciated, there can be many steps to be performed in order to complete the financial transaction. For example, the market service may receive an Open World partial payment as a down payment first, perform the Proprietary World transaction, and finally complete the Open World payment. (A buyer may want to use a credit accrued in a Proprietary World to purchase an item or a buyer who does not have an identity in particular Proprietary World but the buyer may want to purchase an item for another user who has an identity in the particular Proprietary World.)

In step 518 the buyer and seller both have the opportunity to rate each other's performance using their Proprietary World identities. This is optional, but recommended to enable an accumulation of reputation information.

In order to facilitate commerce and other transactions between participants in a Cross World environment or between participants in a Proprietary World, an appropriate user interface is provided. While a lightweight Internet browser could be built into an application, it will generally not be able to provide a compelling user experience, nor one that maintains the desirable flow and immersion aspects of interaction with a Proprietary World. Generally, a browser is a “pull” system, meaning that the browser navigates to a particular site and extracts a snapshot of the information. To obtain an update, the browser requests a new update. This is sub-optimal as the browser does not know if the data has changed, so must request a refresh more often than may be optimal or indicated. Equally, the browser may miss several changes between refreshes. Further, the user experience is not as flexible as needed to retain a low impact on the sensory space and other aspects of a Proprietary World.

One solution for this is a system that “pushes” a change in information to a client. An example is a Chat-based system or the like. The goods and services appropriate for a particular participant to trade are usually quite limited. They need to be appropriate for the particular Proprietary World, available in the particular instance of that particular Proprietary World, and typically they must be suitable for the particular participant's skills, alliances, competencies within the environment, levels of play, etc. Collecting and entering the appropriate criteria for a search can be a time consuming business. Further the criteria are likely to change over time as the Worlds develop and as the user's skills change.

### Real Time Commerce Transactions

Many Proprietary World items and services have a value proposition that includes a strong dependence on time. The trade may involve one-one contact, so both participants come together at the same time, or the item for sale may have a limited shelf life, i.e., the item for sale is valid for a certain period of time. A more immediate experience or initiation of a transaction opportunity is likely to enhance impulsive buying behavior which will promote commerce within the system. The participants will be using their Proprietary World identities. However, trust and reputation in existing systems generally bind to Open World identities, or they bind to Proprietary World identities without providing a way for others to access the trust and reputation from outside of a particular Proprietary World. Thus, in a conventional environment, a user is not able to build these attributes over multiple Proprietary World experiences and to utilize their earned trust and reputation to facilitate transactions in Worlds other than those in which the trust and reputation were originally earned. Further, the social dynamics of Proprietary Worlds (i.e., when viewed across different Proprietary Worlds) do not work the same way for each such world. For example, the method of trade in some worlds is closer to a market bazaar with vendors all present in a single space offering their goods by yelling. In some embodiment, a market place service that is immersive or compatible to that environment is provided using the Identity Bridge System.

In one embodiment, an automated agent user (e.g., roBot, “bot”) is used to automatically invite users of the Market Place service system. The users may be registered as a buddy of the bot so that the bot can communicated with users as if an individual user communicate with other users in his/her buddy list. Herein after, such a market will be referred to as a “Bazaar.” In the Bazaar, any communication that a user sends to the bot may be processed by the bot and result in either:
a return message indicating some requested action has been taken; or,
the message being broadcast, possibly with some modification, to all users registered with the bot; or,
a message, possibly with some modification, being forward to one particular user.
   In certain aspect of the Bazaar, commerce transactions in Bazaar are funneled into the automated agent user, which makes easy to trace commerce transactions and to apply a fee to some or all commerce transactions facilitated in the Bazaar.

In one embodiment, the Market Place service system may support several Bazaars and enable the user to choose which Bazaar(s) to be registered in. In this embodiment, the Market Place service system may deploy a separate bot for each Bazaar (or Proprietary World that has a market for). When a user selects a Proprietary World identity to use, the Market Place service system can register the user with the bot that is responsible for a particular Bazaar based on the matching Proprietary World. Further, at the time of registration, for each Proprietary World Identity associates with the user, the Market Place service system registers the user with a Bazaar corresponding to a Proprietary World that matches the Proprietary World Identity. In another embodiment, based on the user information, the Market Place service system may register all users in the relevant Bazaars (or expected to be relevant Bazaars) periodically.

The aggregated trust and reputation capabilities of the Identity Bridge system also provide a convenient way for the implementers to collect and present commercial reputation information for the Proprietary World identity being used. This is particularly valuable to a user who is moving from a first Proprietary World to a second Proprietary World. While the Proprietary World identity and attributes may be different, the quality of service and thus reputation of the user behind those Proprietary World identities will be the same, and will for most purposes, be desirable to transport between different worlds or environments.

While financial transactions may actually be conducted between Open World identities (i.e., real persons), it is important for purposes of anonymity and continued immersion in the Proprietary environment that these identities be kept secret, and maintain the perception that Proprietary World identities are making the transaction. As mentioned above, the Identity Bridge system may be used to manage the relationships involved, since it has a verified/authenticated understanding of the relationship between each Proprietary World identity and its Open World owner.

A further advantage of using the Identity Bridge system is that it has an understanding of the relationships between each Proprietary World identity and its Proprietary World. This enables messages, particularly market place and promotional messages, to be delivered to only those identities for whom it makes sense, meaning those people with Proprietary World identities that can take advantage of the item being promoted. In particular, this increases the efficiency of any promotion as measured by the likelihood the promotion is delivered to someone who will take advantage of it. Without the platform it would be necessary to have users separately enter this information, if they so chose. The information that would be useful includes, but is not limited to:
the particular Proprietary World an identity is associated with;
Proprietary Worlds with which other identities in the user's cluster may be associated;
the particular instance of a Proprietary World that an identity is associated with (generally speaking, it is not possible to move items or identities between instances of Proprietary Worlds)
the team or “faction” that a particular identity is associated with
other groupings, such as guild, clan, tribe, that the user is associated with
some measure of an identity's skill
some aspect of an identity's attributes.

A complete commerce transactions, from advertising through transaction completion, and including exchange of funds and generating a record of the event, can be facilitated while the anonymity of users are secured. In one embodiment, users may be allowed to enter commands similar to “Want to Sell” (WTS) and “Want to Buy” (WTB), in order to provide a familiar User Interface. In such embodiment, a set of commands may be predefined in the Market place system. Examples of the commands may include:
‘add’—Add an avatar to your cluster
‘who’—list avatars in a game
‘task’—get a verification task
‘confirm’—enter a key to complete a verification
‘addstat’—add metadata about an avatar
‘join’—join a group or a chat channel
‘games’—list games registered by the system
‘servers’—list of servers (instances) of games registered to system
‘whisper’—send a message to another user/avatar
‘reply’—reply to a whisper
‘wts’—Want to sell an item
‘wtb’—Want to buy an item
‘list’—list items for trade
‘bid’—bid on an item
‘bidhalf’—bid on an item, except pay half on acceptance of offer, and half on delivery
‘bids’—list bids on an item
‘take’—accept a bit on an item
‘release’—release the second half of money on a ‘bidhalf’ transaction (the trade went well)
‘recover’—keep the second half of money on a ‘bidhalf’ transaction (the trade went poorly)
‘give’—transfer money between participants
‘history’—show a transaction record for the user
‘fees’—show fees in the system
‘drop’—drop an avatar, or task, or stat, or listed item, or bid
‘vote’—vote on some aspect of an avatar
‘refute’—refute a vote or comment on an avatar
‘fund’—add funds to your account
‘payout’—withdraw funds from your account
‘tie’—connect an avatar to a session from an external chat network
‘post’—post a message from an avatar to the avatar's/user's blog
‘help’—obtain help on use of the system
‘tutorial’—obtain a tutorial on use of the system.

As well understood, users can input free text form commands to interact with the Market place system.

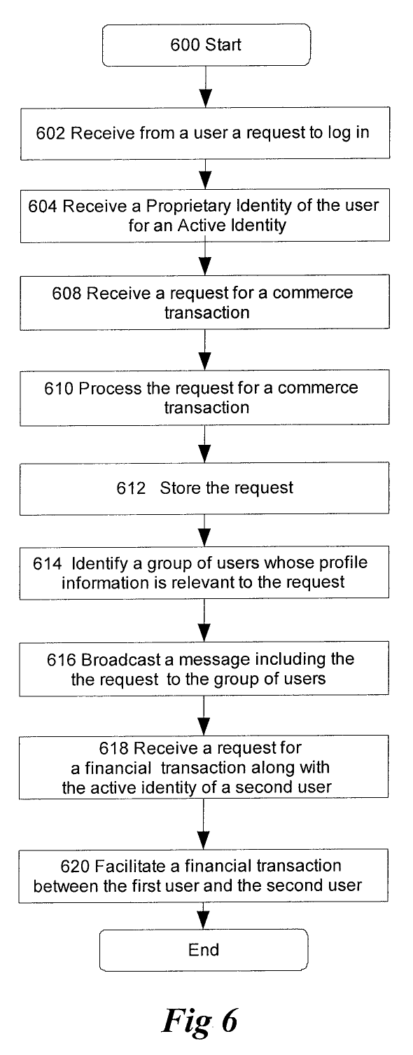

Referring to FIG. 6, a flow chart showing how the steps taken to facilitate commerce transactions in a particular Market Place service system such as a “Bazaar” in accordance with an embodiment of the present invention. In step 602, the user logs on a desired Market Place service system. The Identity management service (or the Identity Bridge system) may provide a User Interface for the user to engage in commerce activities by presenting a list of available Market Place services. In this embodiment, several Market Place services are also managed by the identity management service of the Identity Bridge system and the user logs on to the identity management service first and then select a desired market place service. In an alternative embodiment, a particular Market Place service may be a stand alone system that operates independently from the Identity Bridge System. Such Market Place service system may include an identity management service component. In that embodiment, the user may register with the Market Place service system using a real identity. The market place service may assign a registered identity for the user. The user can claim or create several Proprietary identities through the market place service. The Market Place service system may use the Identity Bridge system to verify each claimed Proprietary identity. Upon verification, the Market Place service system associates the Proprietary identity with the registered identity. The Market Place or the identity management system may store a set of Proprietary identities for the user. The user may directly sign into a Market Place service system. For the purpose of discussion, it is assumed that the user register with the Market Place service system to perform commerce activities in a Cross World environment.

In step 604, after the user logs on, the set of Proprietary World identities associated with the user's registered identity may be obtained from the identity management service that retrieves the requested list of identities by creating and passing the appropriate query to its data store. In step 606, the Market Place service system receives Active Identity of the user. The user chooses a Proprietary World identity to be the Active Identity (the Proprietary World identity to be used for the session, or until the user selects an alternate). The user may be allowed to choose a desired identity only from the listed identities. In this manner, additional verification would not be required.

In step 608, the Market Place service system receives a request for a commerce transaction. For example, the user may issue a “Sell” command as a request for the commerce transaction. The command may be entered by the user typing “Sell: item description” directly into the message window. Alternatively, the User Interface may present a button along with the item description to sell. The user can press the button to issue the “Sell” command. This set of command input methods is not exclusive, and a range of variations is envisioned. In one embodiment, the user device transmits the command as a message to the Market Place service system. In step 610, the Market Place service system processes the command and broadcasts the message to a group of users whose profile information is relevant to the command. For example, the Market Place service system makes the item available for potential buyers. For example, the sale item information may be passed to the relevant recipients. The relevant recipients may be filtered based on their affiliations with a particular Proprietary World, their presence information, or the user preference information.

In step 612, the command may be stored as part of history in a data store. This is recommended particularly for services with a commercial component as it can form the basis of an audit trail. The automated bazaar user also stores information about the item for sale in the market store for later retrieval. The information stored for retrieval may include, but is not limited to:
the seller
bidders and eventual buyer.
prices asked, bid, and finally paid
item details
dates and times of listings, bids, and settlements
Proprietary World, and Proprietary World information
vote and reputation feedback
images, if not already stored
account balances

The information can be used for, among other things;
tracing the flow of money thru the system
determining the level of activity, especially commercial activity in Proprietary Worlds and instances of Proprietary Worlds,
determining pricing guides of items
watching pricing trends
providing a record of a transaction should buyer or seller have concerns
determining how much attention each advertisement generates

In some embodiments, the automated agent user (bot) can optionally generate a new message which it passes from a “seller” back to the Market Place service system. The bot may simply use the original message provided from the seller or generate a message based on the received message. In step 614, the automated agent user may identify a group of users whose profile information is relevant to the request. Some times, all the users may be identifies to be relevant to the request. As will be appreciated, relevance would be measured by various factors. For example, relevance is measured by whether the user (or the identity being used by the user) has access to the Proprietary World and particular instance of the Proprietary World in question. Alternatively, each user may specify user preference with the Market Place service system about Proprietary Worlds or item/services that the user thinks relevant to the commerce transaction.

The user can control the number of items being displayed to the user. The Market Place service system may use a threshold number to limit the number of items being shown to users. In step 616, the Market Place service system (or automated agent user) broadcasts this message (e.g., “Sell” command) to all users in the identified group or all users registered as buddies of the bot. The user device receives the message sent by the Market Place service system and displays the received message to the user. As will be appreciated, the message is displayed in a suitable form on the user device, such as a window that can render HTML, so that a rich viewing experience can be provided. This enables images of the item for sale, for example, to be displayed along with a seller's information including reputation. The Market Place service system implement the request from the user, for example, generates forms of highlighting in response to such request.

In some embodiments, the Market Place service system may provide various services, including, but are not limited to, 1) filtering the broadcast to only those users who for whom it would be relevant; 2) examining the message to determine if additional promotional capabilities have been requested (including agreement to pay for them), in additional fields; 3) storing the message for retrieval by a browser style application. In step 618, the Market place service system may receive a request for a financial transaction between two users. The requests may include active identities of the users who are parties of the financial transaction. In step 620, the Market Place service system facilitates the financial transaction though a third party finance service.

Although the “Sell” command is used in connection of the description of FIG. 6, it is noted that other commands are implemented in a similar manner to the “Sell” command through the Market Place service system and the Identity Bridge system. Examples of the commands may include “Buy” for items that are desired for purchase, “Offer” to make an offer to a seller to purchase what they have advertised and “Pay” to transfer funds between a buyer and seller. The “Offer” and “Pay” commands are transmitted from/to the seller/buyer and are not broadcast to other participants.

In one embodiment, when the requested commerce transaction is completed, a notification, for example the transaction information including “confirmation number,” item information, seller, buyer information, etc., is generated and stored in storage of the third party and/or the Market Place service system. The notification is also transmitted to all participants in the transaction for record keeping.

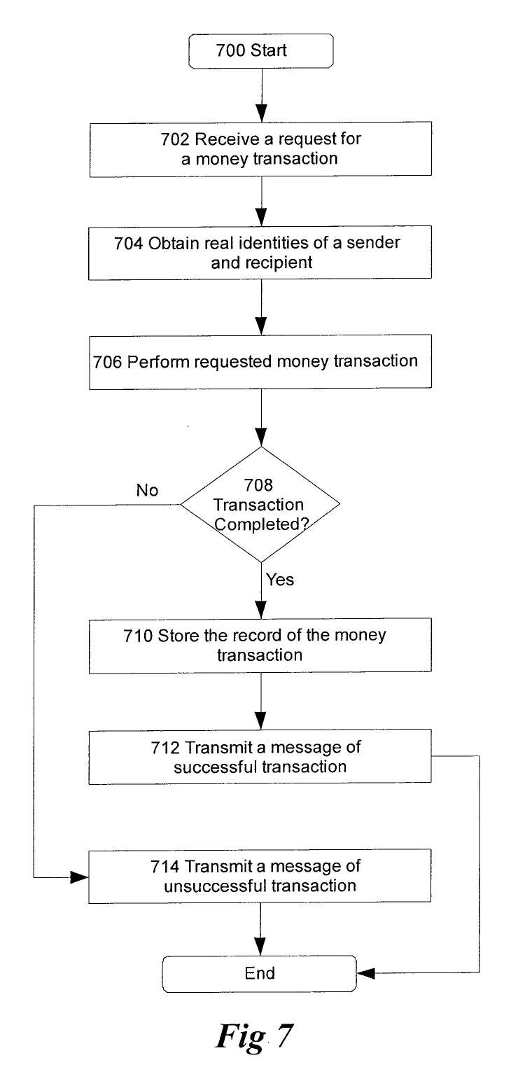

Referring now to FIG. 7, a flow chart shows how the steps taken to facilitate a financial transaction between two users in the Cross World environment in accordance with an embodiment of the present invention. As with FIG. 6, it is assumed that a third party financial service provider is used for facilitating any financial transactions between the users. It is further assumed that the third party financial service provider does not have Proprietary identity or registered identity information about the parties of a transaction. In some embodiments, the third party will receive a transaction request with the registered identities and obtain real identities of the parties from the Identity Bridge system or the Market Place service system.

In step 702, the third party financial service provider receives a request for a money transaction between a first user and a second user. In step 704, the third party financial service provider obtains real identities of the first and second users. In one embodiment, the request may contain the real identities of the first and second users. In another embodiment, the third party financial service provider may obtain the real identities from the Market Place service system or the Identity bridge system based on the registered identities or the active identities of the first and second users. In step 706, the third party financial provider completes the financial transaction with real world identities associated with the registered identities. It is determined whether the transaction is successfully completed in step 708. If the transaction is successfully completed, the third party stores the history of the transaction in step 710. The third party transmits a message indicating a successful transaction to the Market Place service system in step 712. In the message, the registered identities may be included. The Market Place service system may match up the registered identity with the Active Identity for each user and generate a notification of the transaction for the users. The notification may contain the Active identities instead of the real or registered identities of the users. If the transaction is not successfully completed, the third party may transmit a message indicating unsuccessful transaction along with the reasons why the transaction is unsuccessful. The Market Place service system may collect additional information from the users and transmit another request to the third party. As mentioned above, the third party service provider may be any suitable online financial service provider that is to be trusted to retain privacy and money, but may also be required to reveal the relationship under pressure of real world government or legal demands.

### Promotions/Advertising for Proprietary Worlds

Existing systems for promoting items to participants in a Proprietary World have little or no way to match promotions to participants who would be able to take advantage of them. This means that much of an entity's promotional money is wasted. This loss can be managed by larger entities that might have the ability to deliver on promotions in a wide range of Proprietary Worlds and instances over a wide range of times. The loss is almost unmanageable for smaller entities restricted to delivering promotions in a single Proprietary World or instance, or a small number of Proprietary Worlds and instances and with possible limited times when that promotion can be delivered. In some embodiments, promotions/advertisement campaigns may be sent to the participants of Proprietary Worlds who are able to take advantage of those promotions. The Identity Bridge system may support a promotion system for Proprietary Worlds that addresses the above-mentioned problems.

The promotion service may be a part of the Market Place service or the Identity Bridge system. The promotion service may be implemented as a stand alone system. The promotion service accepts promotions from users registered and active in the Identity Bridge system. The promotion service may immediately deliver those promotions to any or all other users who share the same Proprietary World, the same instances, and other attributes, including presence. The promotions may only be delivered while the user is active in the system for the particular Proprietary World and instance indicated. As will be discuss in detail below, the promotion service provides mechanisms for more sophisticated users to extend their presence in the system, and thus the time frame and set of instances their promotions are considered valid. As with the Identity Bridge system, the promotion service may be independent of all Proprietary Worlds and can be used for any items appropriate to any of the Proprietary Worlds, Further, by using Identity Bridge system, the problems of context, identity and reputation may be resolved.

In some embodiments, filtering may be used to ensure that only those promotion messages that are relevant to a user's Proprietary World identity are delivered to the user. The filtering can also be configured to recognize items for trade that are relevant to any Proprietary World identities associated with one user. In addition, the number of items to be delivered to a user may be controlled by the system or the user by using different criteria for the filter. For example, if the flow of items is small, the system is configured to set different criteria to filter larger set of items to be shown to the user. Likewise, when the flow is large, the system can be configured to restrict the flow using more criteria, for example, attributes of the Proprietary World identity in use, such as level, skill, profession, etc.

In some embodiments, available items and promotions may be searchable based on search key word. The Market Place service may receive a search query from the user and obtain search results. The Market Place service may present the search results in order of relevancy. The user may be able to specify what criteria to use to sort the search result. For example, the user can specify to sort the search results based on the price for sale, percentage of the promotion, etc. In one embodiment, the Market Place service may allow the user to search available items or promotions based on a category of the item.

The reputation information may be used one of the criteria to create an understanding of a participant's network of other participants. Items being promoted by participants in a participant's network can be given additional promotion to the participant. For example, the filtering could be configured to only show items from somewhere in the participant's network, or where the seller or buyer has been voted on (favorably) by someone in that network. A query on the Identity service's database can retrieve this information. The query can be configured to ensure that the analysis limits the degree of separation between the participant and the items sought.

For the sake of discussion, it is assumed that the promotion service is a part of the Market Place such as a “Bazaar” described in connection with FIG. 6. As discussed above, the Market Place service may deliver a list of currently available items that a group of participants want to sell or buy. The promotion service may enhance the Market Place service by:
1. Enhancements to the rendering of items listed in the system. For example, a particular item could be rendered in bold, or with an extra picture, or additional frequency, or a URL, etc. Each enhancement or set of enhancements being applied in return for an additional fee to the system.
2. Advertisements inserted into the stream of listings. This includes paid advertisements for items that need not be listed in the system. Further, there may be additional placement opportunities. For example, the advertisements may appear in the client UI while the user is looking at some aspect other than the listing of items.

Revenue is generated by charging fees for enhancing users' listing of items for trade. Advertising Revenue is also generated either by charging placement fees for advertisements delivered through the system or by charging a fee each time a link in an advertisement is clicked on. Note that in one embodiment, listings include items that can be purchased through the system. Advertisements can include items that are not directly available through the system. Fees can be charged for each promotion purchased, including improved rendering attributes, presentation to particular groups of users, etc.

Promotions may be distributed among participants of a Proprietary World even if they are not currently present in the Proprietary World. This would be useful for those participants who wish to continue some aspect of their Proprietary World experience into the Open World, or while engaged in some other Proprietary World. An example would be a participant who offers guiding services in more than one Proprietary World, or who chooses to engage in Open World activities while waiting for a particular item to become available or asked for. The use of the Chat System and its protocol to deliver messages to the client is also a favorable way to reach other devices. Many mobile phones, for example, understand the Chat protocols. Thus, the measure of presence can be extended to include:
presence of a participant in a Proprietary World;
presence of a participant in any Proprietary World of a participant's Identity Cluster
presence of the user in the system through Open World systems.

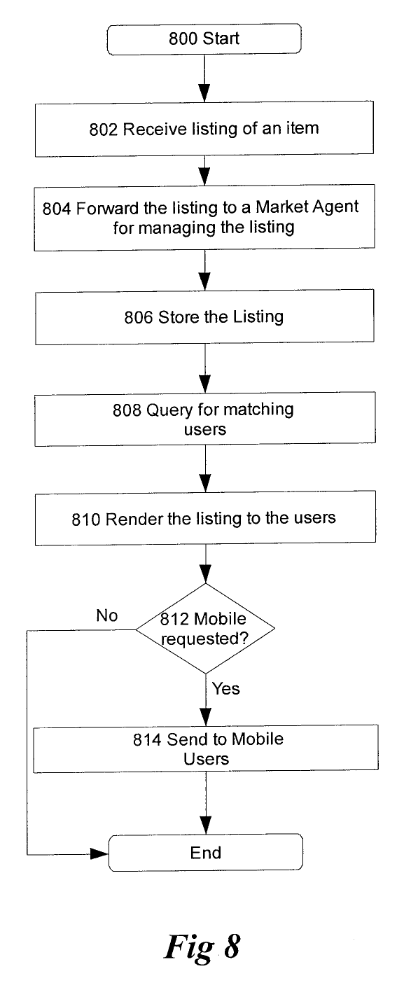

With reference to FIG. 8, a flow chart shows the steps for posting an item for sale in the Market Place Service. As with FIGS. 6 and 7, it is assumed that the user has logged on to the Market Place Service and has selected his/her active Proprietary World identity before requesting services. The list of possible identities is obtained from the Identity Platform and is assumed to have been previously configured. In step 802, the Market Place service receives a listing for an item that a user wishes to sell. The request for the listing is transmitted from the user device. For example, the users may enter “WTS: Guide to Fargo Mine Quest” and specify bold for their listing. In some embodiments, a sophisticated user interface may be provided to assist the user in entering the listing for an item. The set of possible enhancements that may be specified to the listing includes, but is not limited to: bold; italic; font size; picture; extra pictures; placement in set of listings; distribution to mobile devices; distribution when user is not present online; distribution to all Proprietary World identities; etc. The user device sends the listing to the service over the chat or similar protocol.

In step 804, the Market Place service system passes the listing to the automated agent user (e.g., Bazaar bot) responsible for managing the listings. The Market Place service system may present the user with the listing so that the user can verify the content of the listing. In some embodiments, the Market Place service system may receive from the user the fee for the listing enhancement that was requested (bold, in this case). In step 806, the listing is stored in a database where it can be retrieved for users requesting a listing. This storage mechanism may also be configured with the necessary triggers to establish an audit trail.

In step 808, in the Market Place service system, the automated agent user may query its buddy list (list of users who have and are connected to the system). The automated agent user may also ask the Identity Bridge system to obtain information about the users sharing the same Proprietary World and Instance as the Listing user. In addition, the listing user can ask the Market place service system (automated agent user) to broadcast the enhanced listing only to a specific group of the users. In step 810, the Market Place service system renders the listing according to the enhancement request specified (or purchased) by the user. For example, the listing is rendered in bold. An enhancement (particularly as the flow of listings increases) is to further restrict the set of users who receive a new listing based on whether they, or someone know to them have previously interacted with the listing user, and/or whether posted a positive experience or not. The listing is sent to the set of selected users.

It is contemplated that the listing user can target a group of users in various ways. For example, the service may be able to communicate with other service providers such as a mobile service provider. In one embodiment, the service may transmit messages including promotions/advertisements to mobile devices as illustrated in steps 812 and 814. In this embodiment, the listing user will have had the opportunity to specify that the listing is sent to mobile users. The listing user may have had to pay a fee for this extension to the service. The service then checks for users who have requested to have messages sent to their mobile devices (and in so doing, entered their mobile address and specified any other criteria the system wishes to provide for them), and sends out messages to their addresses using the chat system. When the user's mobile device receives the Listing message, it displays the message to the user using the rendering generated by the server. In this particular implementation, any HTML tags are honored, such as <b> for bold.

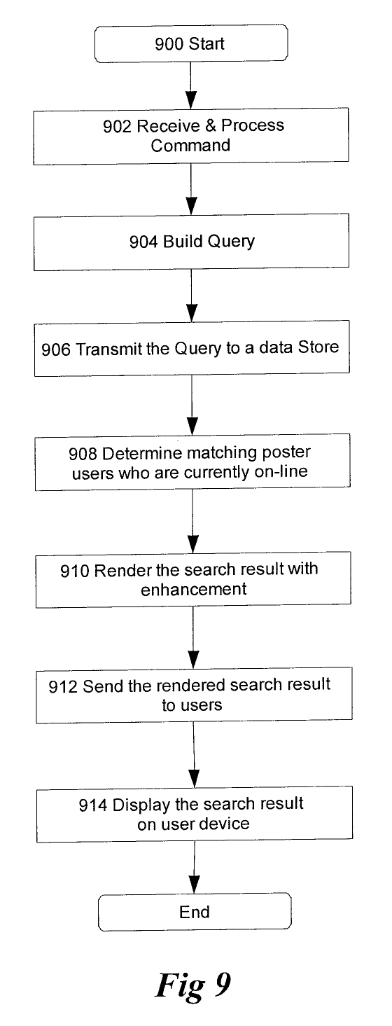

Referring to FIG. 9, a flow chart that presents a user with a list of users or items that is relevant to a request in accordance with an embodiment of the present invention. It is to be assumed that the user logs on and selects an active identity from the set of Proprietary identities which have been verified in the Identity Bridge system. After selecting the active identity, the user may submit a command requesting items listed for sale in the Market Place service. As will be described in detail below, the user may, for example, enter a “List” command via a user interface. In one embodiment, the user may enter a search keyword about the item. The user may be able to specify how to sort the search result, or how to narrow the search result. The user device sends a message including the user request over the chat or similar message system. In step 902, the Market Place service receives the message and passes it the automated agent user, or the Bazaar bot. The command or search keyword is extracted from the message. In step 904, the Market Place service or the automated agent user builds a query to obtain a group of users or a set of listings that may be relevant to the request. For example, a query may be built based on information about the requesting user—which Proprietary World and Instance the requesting user is from. In step 906, the query is passed to a data store to obtain the search result for the query. In some embodiments, a group of users who are online is compared to the results of the query to ensure only those listings which can be immediately acted up on are surfaced as illustrated in step 908. Alternatively, a group of users whose profile information is relevant to the requested item, the search keyword, etc. will be queried and obtained.

In step 910, the search results, for example the listing of items, may be rendered with any enhancements the listing users have specified and/or paid for. In one embodiment, the listings may be sorted according to a degree of relevancy. The automated agent user may consider whether the user has previously interacted with any of the listing users, whether someone known to them has, etc. In another embodiment, the listing may be sorted or filtered according to whether people known to the user have provided favorable reviews of the listing users. In step 912, the search results are sent to the client over a message system such as a chat system. In step 914 the search results are displayed to the user in order that can assist the user to easily locate the item. Another possible service or function enabled or facilitated by the inventive systems, apparatus, and methods is that of enforcement or implementation of membership policies for a group interacting within a Proprietary environment.

### User Interface

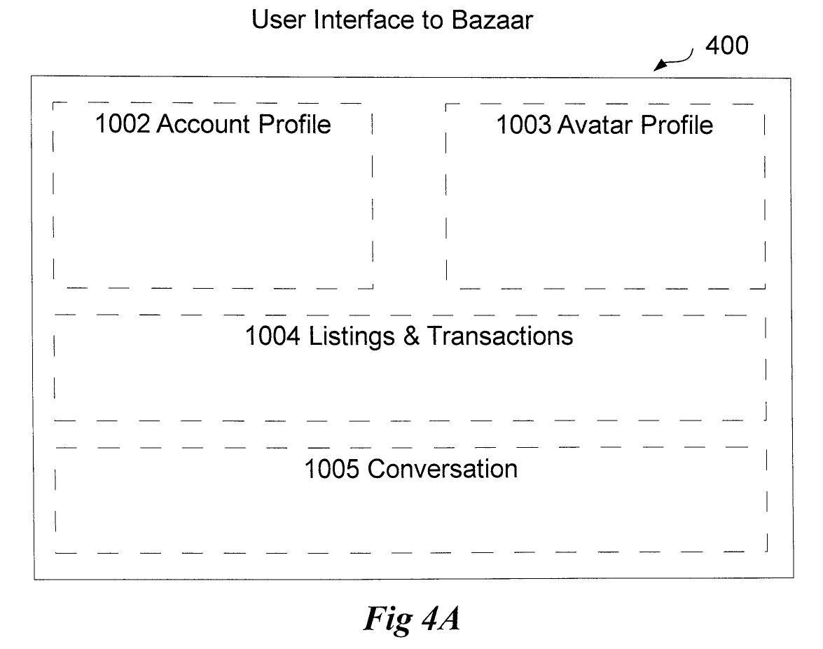

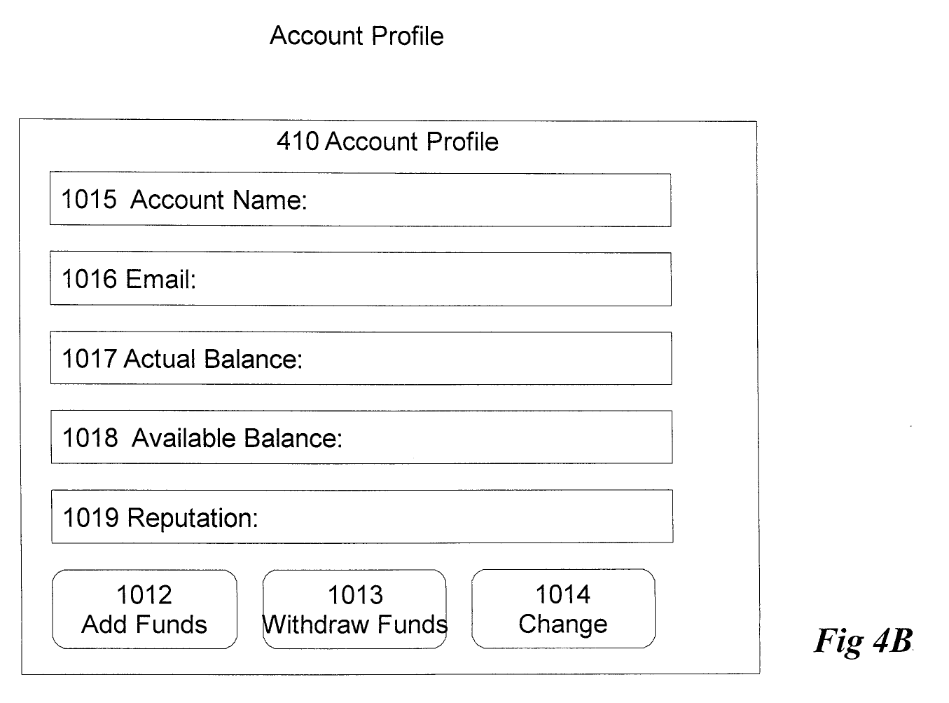

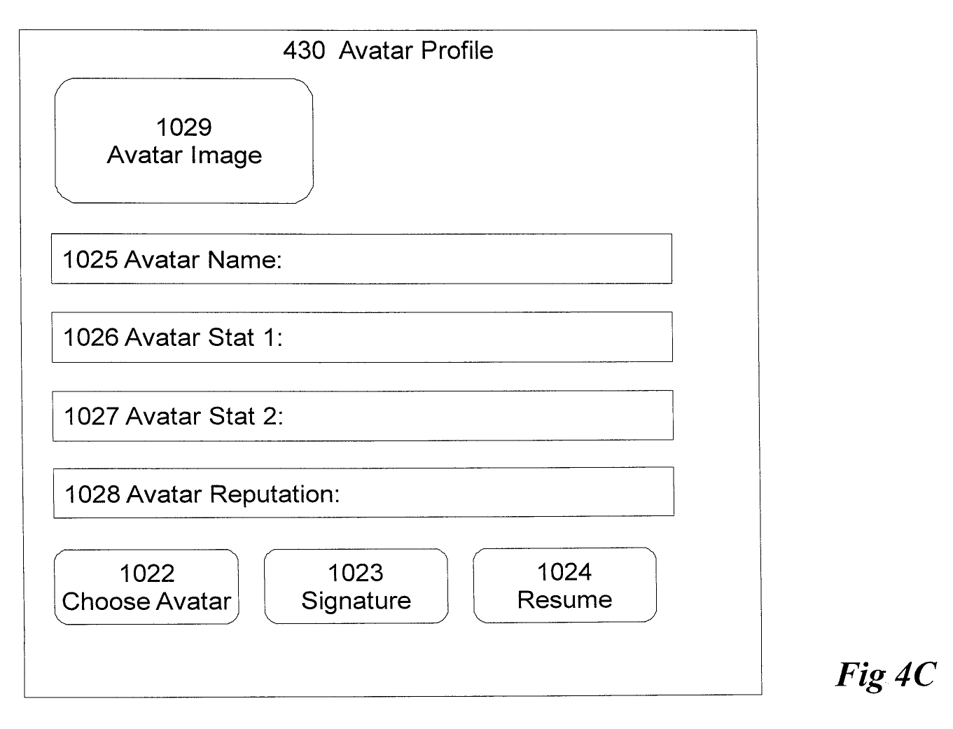

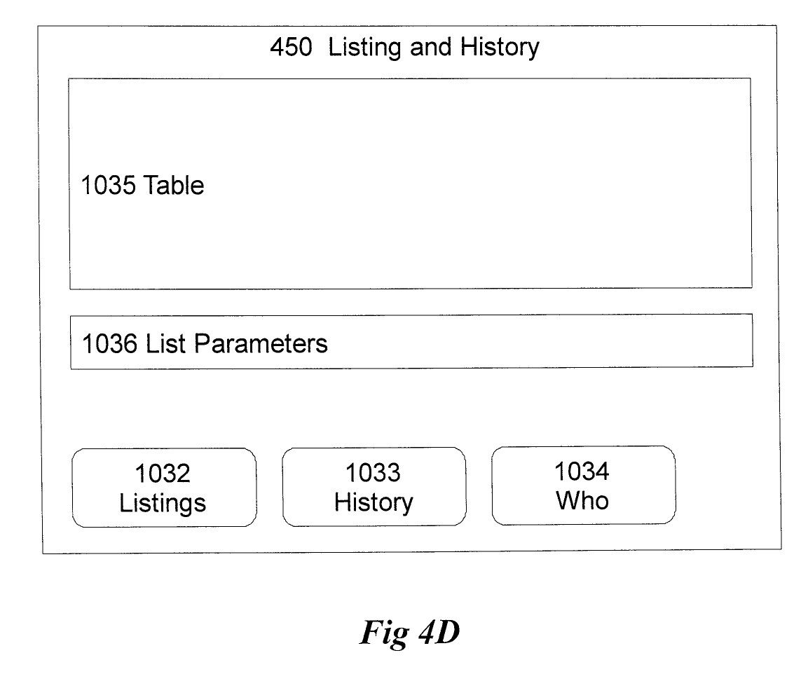

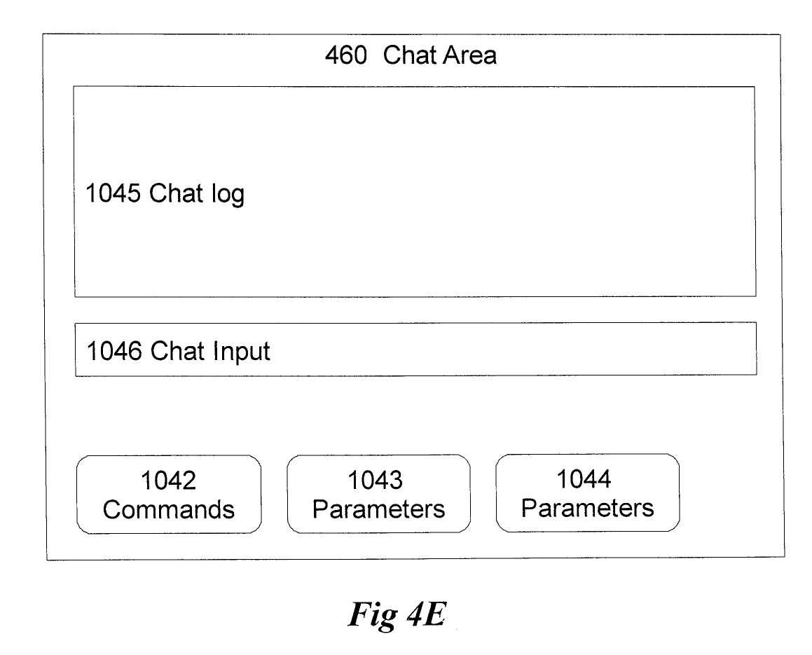

FIG. 4A shows an exemplary screen displaying a main user interface for the Market Place service. As shown, the main user interface 400 may be part of an application, a web browser page, an appliance, etc. The main user interface 400 may also provide the user with surface management tools (such as minimize, maximize, open, close, etc). The main user interface 400 may include sub areas such as, an Account profile 1002, an Avatar Profile 1003, a Listing and Transactions 1004, and Conversation 1005. When each of the sub-areas 1002, 1003, 1004, and 1005 is selected, a detailed view screen is displayed as shown in FIGS. 4B, 4C, 4D, and 4E respectively. As will be appreciated, many other sub-areas such as advertisements, contact lists, promotion, etc. can be also displayed through which the user can view, update, and/or create information via the user interface. In one embodiment, the sub-areas may be presented within one screen, for example, within the main user interface 400.

Referring to FIG. 4B, an exemplary screen for Account Profile 420 depicts a detailed view of information associated with the account held by the user is presented. In the detailed view, the account name 1015 (optionally, including an image of the active identity), the account's email address 1016 (or any other desired contact address information), the balance of funds 1007 in the user's account, and the balance of unallocated funds 1008 (those funds which have not been otherwise allocated, for example to a pending purchase) may be presented. In addition, the user's overall reputation in the system may be displayed along with the account profile information.

The user may be presented with several menu options to update the profile information, to complete a financial transitions or the like. For example, Box 1012 represents a button the user can press to initiate a transfer of funds in to their account—typically using a third party financial system to process a credit card transaction or bank transfer. Box 1013 represents a button the user can press to with draw funds from the system, again typically using a third party financial system. Box 1014 represents a button the user may press to initiate a process for updating any of their information (such as password, email address, etc.)

Referring now to FIG. 4C, an exemplary screen for Avatar Profile 430 depicts a detailed view of information associated with an Avatar the user has registered with the system, after the user select the UI Avatar Profile sub-area 1003 from a main user interface. In the Avatar Profile screen, “Avatar Name” 1025, “Avatar Stat1” 1026, “Avatar Stat2” 1027, and “Avatar Reputation” 1028 are displayed. In one embodiment, as a default, the “Avatar Name” 1025 may display Avatar's name. Possibly an Avatar image 1029 (image of the active identity of the user) may be also displayed. The “Avatar Stat1” 1026, “Avatar Stat2” 1027 show various data about the avatar that the user considers to be interesting (or the system may use default data if no preference has been indicated). The “Avatar Reputation” 1028 shows the reputation of the avatar displayed in “Avatar Name” 1025. One or more forms of reputation may be displayed depending on the design of the system.

The user may be presented with several menu options to manipulate the screen, update the profile information, or the like. For example, Box 1022 enables the user to select a different avatar to display. Box 1023 enables the user to obtain a signature for an avatar. An avatar signature is similar to the signature that some users append to email messages or forum posts, except that it relates to an avatar rather than a person. Box 1024 represents a button the user may press to see a more detailed resume of the avatar, possibly including its relationships with other avatars. In some embodiments, the user can view profile information of an avatar that belongs another user of the system. Typically, the system would limit data displayed and limit data modification if an avatar of another member was being shown.

In FIG. 4D, a Listing and History 450 screen depicts a detailed view of area used to show lists of information associated with users or avatars. A user can input a desired category to view through the screen. For example, Box 1032 represents a button where the user can request a table of items for sale in the system. Box 1033 represents a button where the user can request a table of transactions the user has made in the system. Box 1034 represents a button where the user can request a table of other users or avatars in the system. Box 1036 provides a space for the user to enter additional information into the system to constrain the number of results shown in the table. For example, when obtaining listings from the system, the user may specify the lists to only include those items from a particular game or instance.

Referring to FIG. 4E, after a user selects the Chat Area 1006 from the main UI screen 400, a Chat Window 460 is presented to the user so that the user can communicate with other users in real time. As will be appreciated, such window is advantageous as it enables more experienced users to manipulate data more efficiently, both in terms of screen resources required, and speed of entry for the user. Box 1045 is the chat log where all chat messages typed in by the user and all chat messages received by the user are displayed. Box 1046 is where the user may enter a command and its parameters by hand. The command is then passed through the messaging system to the agent, and both the message and the response are displayed in Box 1045.

Box 1042 provides an alternative command entry system suitable for the novice, in which commands are selected from a drop down list of available commands. Boxes 1043 and 1044 provide the opportunity for the user to specify additional parameters to be sent along with the command. The command, parameters, and response from the agent are all displayed in box 1045.

Boxes 1045 and 1046 may be used by an advanced user to access all aspects of the system, and are particularly advantageous when screen area is limited, such as on a mobile device or while participating in a Proprietary world.

The boxes in FIGS. 4B-4E are also notable in that they may work together. For example, Box 1042 might notify 1035 the listing table in response to a “sell” command from the user so that the list of items for sales is updated, and so on.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer implemented method for providing a commerce service within a cross world environment by utilizing an intermediary system that verifies proprietary identities for the commerce service, the method comprising:
obtaining an active identity of a first user, wherein the active identity is selected from proprietary identities associated with the first user;
receiving from the first user a request for a commerce transaction via a user device;
determining a type of transaction and an item related to the request;
identifying a group of users whose profile information is relevant to the item;
broadcasting a message about the request to the group of identified users;
obtaining an active identity of a second user, wherein the second user is selected as a participant of the commerce transaction;
facilitating the commerce transaction between the first user and the second user; and
storing the request and a result of processing the request.

2. The method of claim 1, further comprising providing the first user with a list of proprietary identities associated with the first user in order to assist the first user to select a desired proprietary identity for the active identity, the list of proprietary identities being obtained from a data store.

3. The method of claim 1, further comprising if the type of transaction is a purchase of the item, identifying seller users who currently indicate a sale of the item.

4. The method of claim 1, wherein a list of the identified seller users and the information about the identified seller user are presented to the first user.

5. The method of claim 4, wherein the first user selects the second user from the list of the identified seller users.

6. The method of claim 3, wherein the information about the identified seller user includes reputation information about the identified seller user.

7. The method of claim 6, wherein the information about the identified seller user includes price information and description about the item that the identified seller user indicates to sell.

8. The method of claim 1, wherein facilitating the commerce transaction includes:
communicating with a third party finance service for a finance transaction between the first and the second users;
obtaining a notification about the finance transaction; and
transmitting the notification to the first and the second users.

9. The method of claim 1, wherein facilitating the commerce transaction includes enabling the first user and the second user to transfer an ownership of the item.

10. The method of claim 1, further comprising, if the first user is new to the commerce service, registering a real identity of the first user and a plurality of proprietary identities of the first user.

11. The method of claim 10, wherein each proprietary identity is verified as to whether the first user is an owner of the proprietary identity through the intermediary system.

12. The method of claim 11, wherein the intermediary system is a third party system.

13. The method of claim 1, wherein the profile information of a user includes item listing information that the user has submitted.

14. The method of claim 1, wherein the profile information of a user includes a proprietary world corresponding to an active identifier of the user.

15. The method of claim 1, wherein the profile information of a user includes presence information of the user.

16. The method of claim 1, wherein the user device is a mobile device, a wireless computing device, a PDA, or a personal computer.

17. A system for providing a commerce service within a cross world environment by utilizing an identity bridge system that verifies an active identity of a user for the commerce service, the system comprising:
a managing component for:
providing a list of proprietary identities associated with a first user when the first user logs onto the system;
receiving from the first user an active identity selected from the list of proprietary identities associated with the first user; and
receiving from the first user a request for a commerce transaction; and
a market agent component for:
processing the request to determine a type of transaction and an item related to the request;
identifying a group of users whose profile information is relevant to the request; and
broadcasting the request along with the active identity of the first user to the group of the users,
wherein the managing component forwards the received request to the market agent component.

18. The system of claim 17, further comprising a storage component for storing user related information for registered users.

19. The system of claim 18, wherein the storage component stores a result from processing the request and information about the commerce transaction.

20. The system of claim 19, wherein the market agent component obtains an identity of a second user who is a party of the commerce transaction and facilitates the commerce transaction between the first user and the second user.

21. The system of claim 20, wherein if the type of transaction is a purchase of the item, the market agent component identifies seller users who currently indicate a sale of the item.

22. The system of claim 21, wherein the first user select the second user from the list of the identified seller users.

23. The system of claim 22, wherein the identity of the second user is an active identity of the second user.

24. The system of claim 22, wherein the active identity of the first user is used to represent the first user and the active identity of the second user is used to represent the second user for any activity during the commerce service.

25. The system of claim 17, wherein the item is one of goods, service, reward points, skill set, or proprietary money which can be exchanged in a particular proprietary world.

26. The system of claim 17, wherein if the type of transaction is a sale of the item, the market agent component identifies a group of potential buyer users.

27. The system of claim 26, wherein the group of potential buyer users are filtered based on the user profile information.

28. The system of claim 17, wherein the market agent component communicates with users via a real time chatting.

29. The system of claim 17, wherein the market agent component enables users to communicate via a real time chatting.

30. The system of claim 17, wherein the market agent component enables users to communicate via exchanging a set of commands.

31. The system of claim 17, wherein the set of commands are predefined.

32. The system of claim 17, wherein broadcasting is facilitated though an email.

33. The system of claim 17, further comprises a plurality of market agent components, each market agent component being responsible for a corresponding proprietary world.

34. The system of claim 33, wherein each market agent component is integrated into the corresponding proprietary world.

35. A computer implemented method for facilitating a financial transaction within a cross world environment wherein a user registers a proprietary identity to represent the user's real identity for the financial transaction, the proprietary identity being verified through a third party service, the method comprising:
receiving a request for the financial transaction between a first user and a second user, the request including proprietary identities representing the first and second users;
obtaining real identities of the first user and the second user based on the proprietary identities;
gathering information necessary for the financial transaction using the real identities of first user and the second user;
performing the financial transaction between the first user and the second user;
generating a message to notify about the performed financial transaction;
transmitting the message in which the proprietary identities is used to represent the first user and the second user; and
storing history of the financial transaction.

36. The method of claim 35, wherein obtaining real identities of the first user and the second user includes communicating with an identity management service which maintains identity information for both first and second users.

37. The method of claim 35, wherein the identity management service verifies the real identities of the first user and the second user.

38. The method of claim 35, wherein the financial transaction includes one of a credit card transaction or money transfer transaction.
